(19) United States
(12) Patent Application Publication
(10) Pub. No.: US 2007/0126857 A1
(43) Pub. Date: Jun. 7, 2007

(54) Apparatus, method and computer program product providing synchronization of memory card operation during DVB-H reception

(75) Inventor: Olli Turtinen, Ii (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/583,421

(22) Filed: Oct. 18, 2006

Related U.S. Application Data
(60) Provisional application No. 60/732,694, filed on Nov. 1, 2005.

(51) Int. Cl. H04N 7/14; H04Q 7/20; H04M 11/00

(52) U.S. Cl. 348/14.01; 455/403

(57) ABSTRACT

A method, mobile terminal, embodied computer program, and device wirelessly receive at a mobile device a bursty communication that has receiving periods and non-receiving periods. Memory card operations within the mobile device are synchronized to the non-receiving periods. This is to prevent interference between read/write operations from/to the removable memory card and reception of the communication, where the reception is active during the receiving periods but not during the non-receiving periods. The bursty communication may be a DVB-H signal that employs time slicing, where the DVB-H receiver operates with at least some of its components in a depowered state for conservation of battery energy.

### CROSS-REFERENCE TO RELATED U.S. PROVISIONAL PATENT APPLICATION

This application claims priority to Provisional U.S. Patent Application No. 60/732,694, filed on Nov. 1, 2005, which is hereby incorporated by reference in its entirety.

### TECHNICAL FIELD

The exemplary and non-limiting embodiments of this invention relate generally to wireless communication systems and, more specifically, relate to user equipment or, more generally, user terminals capable of receiving wireless communications signals having a potential to interfere with operation of electronic circuitry of the user terminal.

### BACKGROUND

The following abbreviations that appear herein are defined as:

| | |
|---|---|
| DVB-H | Digital Video Broadcasting, Handheld |
| ETSI | European Telecommunications Standards Institute |
| HW | Hardware |
| MMC | Mass Memory Card |
| PID | Program Information Descriptor |
| PWB | Printed Wired Board (circuit board) |
| QAM | Quadrature Amplitude Modulation |
| TV | Television |
| RS MMC | Reduced Size Mass Memory Card |
| SD | Scan Disk |
| SW | Software |

The document: ETSI EN 302 304 V1.1.1 (2004-11), Digital Video Broadcasting (DVB); Transmission System for Handheld Terminals (DVB-H), submitted with the above-referenced provisional application, is hereby incorporated by reference.

An ability to receive and display TV signals with a mobile terminal, such as a cellular phone, is a new and evolving feature. Presently, this is accomplished through the use of the DVB-H frequency band and related electronic receiver circuitry. The DVB-H frequency band is 470-750 in Europe/Asia. The frequency bands to be used in the U.S. are still open. The overall DVB-H system is specified in ETSI.

In general, the DVB-H standard was derived from DVB-T (terrestrial), allowing for lower power consumption, lower signal strengths and fast movement, enabling TV reception when in a moving vehicle. DVB-H can carry MPEG-4 video streams at 11 Mbits/sec, enabling 30-35 TV streams to a cellular phone at 150-400 kbits/sec. In the U.S., it is expected that DVB-H will be delivered over a 5-MHz segment of the L-band. The L-band spectrum extends from 1440 to 1790 MHz, so if adopted would place the frequencies for DVB-H in the US well above the frequency band used for it in Europe.

The recording of a TV broadcast is a feature that at least some modern mobile terminals will be expected to support. At present, almost all mobile terminals support mass memory that is implemented by a memory card interface, MMC/SD card readers.

Some typical use cases for recording a TV broadcast can include, but need not be limited to: TV recording while watching the same channel; TV recording while watching another channel; TV recording in the background, while performing some other memory card-intensive operation; and watching TV while some memory card-intensive operation is running in the background.

However, it has been noted that at least some memory card operations (read and write) can cause electromagnetic radiation interference (EM I) into the DVB-H band. This EMI has the potential to adversely affect the DVB-H reception and can result in poor DVB-H receiver sensitivity and, in practice, a reduction in the operational coverage area of the DVB-H receiver. That is, the DVB-H receiver, and hence the mobile terminal, need to be nearer to the transmitter to receive an acceptable TV signal than would otherwise be the case if the EMI were not present.

There are seen to be two main EMI sources: the memory card itself and the interface between mobile terminal electronics, such as the phone engine, and the memory card.

With regard to the memory card-induced EMI, it has been found that the amount of EM I is variable, and can depend strongly on the manufacturer of the memory card.

The EMI induced by the interface between the phone engine and the memory card can vary depending on the specifics of the mobile terminal and memory card reader construction. For example, the termination pins (electrical connectors) of the memory card reader and the memory card reader body itself may be poorly shielded, resulting in one source of EMI. Complicating this is the fact that modern mobile terminals can take many different forms of construction. For example, if the mobile terminal is implemented by two circuit blocks (two PWBs), one block will typically include the baseband engine and another block the memory card interface. In this case the memory card interface between the PWB blocks can serve as another source of EMI since the electrical inter-connectivity between the blocks can be carried at least in part by wiring that has the potential to radiation EMI.

While the use of mechanical shielding of the memory card reader can be beneficial in reducing the amount of EMI, it can also have the potential to reduce the usability of the memory card reader as, for example, the overall form factor requirement can be increased.

### SUMMARY

In accordance with one aspect of the invention is a method of operating a mobile device. In the method, a bursty communication is wirelessly received at a mobile device. The bursty communication is characterized by receiving periods and non-receiving periods. Memory card operations within the mobile device are synchronized to the non-receiving periods.

In accordance with another aspect of the invention is a mobile terminal that includes a receiver, a processor, a mass memory interface, and software embodied on a computer readable medium. The receiver is configured to receive a bursty communication, where the bursty communication includes both receiving periods and non-receiving periods. The processor is coupled to the receiver through a receiver interface. The mass media interface is for coupling a removable mass memory device to the processor. The software operates with the processor to synchronize reading and writing operations that pass through the mass media interface with the non-receiving periods.

In accordance with another aspect of the invention is a program of machine-readable instructions, tangibly embodied on a computer readable memory and executable by a digital data processor, to perform actions directed toward synchronizing read and write operations with a bursty communication. In this aspect, the actions include disabling read and write operations for a removable mass memory device when a wireless receiver is receiving the bursty communication. The removable mass memory device is separate from the computer readable memory on which the program is embodied. Further, the actions include enabling the read and write operations when the wireless receiver is not receiving the bursty communication.

In accordance with yet another aspect of the invention is a mobile communications device that includes receiving means, processing means, interface means, and software embodied on a computer readable medium. The receiving means is configured to receive a bursty communication that has receiving periods and non-receiving periods. The processing means is coupled to the receiving means. The interface means is for removably coupling a removable memory device to the processor. The software operates with the processing means to synchronize memory operations that use the interface means with the non-receiving periods. In an embodiment, the receiving means may be a digital video broadcast receiver and the bursty communication includes a digital video broadcast using time slicing as detailed herein. In an embodiment, the processing means may be a digital processor, a microprocessor, a multi-core processor, or a plurality of distinctly separate processors within the mobile communications terminal. In an embodiment, the interface means includes a memory card reader that is configured for removably coupling any of the various memory card devices detailed herein to the processor.

These and other aspects of the invention are detailed with more particularity below.

### BRIEF DESCRIPTION OF THE DRAWINGS

The embodiments of the invention are described herein with reference to the following exemplary drawing figures.

FIG. 1 is a waveform diagram that illustrates a typical network DVB-H reception timing.

FIG. 2 is a waveform diagram that illustrates an assumed worst case network DVB-H reception timing.

FIG. 3 is a simplified block diagram of a portion of a mobile terminal related to synchronization of memory card operation during DVB-H reception.

FIG. 4 is a simplified block diagram of a mobile terminal similar to FIG. 3 but showing additional components.

FIG. 5 is a prior art conceptual structure of a DVB-H receiver that may be used in the embodiments of FIGS. 3-4.

### DETAILED DESCRIPTION

The exemplary embodiments of this invention are applicable to at least the following types of memory cards: MMC, SD, Mini SD, RS MMC and Micro SD. While the advantages of this invention are most pronounced when used in the context of memory cards, these teachings may also be extended to any mass media storage device that is normally removable from a mobile terminal or other portable memory device, such as a flash drive (e.g., thumb drive or memory stick).

The exemplary embodiments of this invention take advantage of the fact that DVB-H transmission is performed in bursts, resulting in the receiving/non-receiving periods of the DVB-H receiver being known. The exemplary embodiments of this invention beneficially synchronize memory card operation to those time periods when the DVB-H receiver is off. When the DVB-H receiver is receiving a broadcast burst the memory card is set to a mode wherein its internal clocks are disabled. The data transmission over the memory card interface is also disabled during this time. When the DVB-H receiver is not receiving a burst, the memory card can be enabled for normal operation, and data transfer can occur over the memory card interface. The overall synchronization of memory card operation can be performed by SW, although a HW implementation, or a joint SW/HW implementation may also be employed.

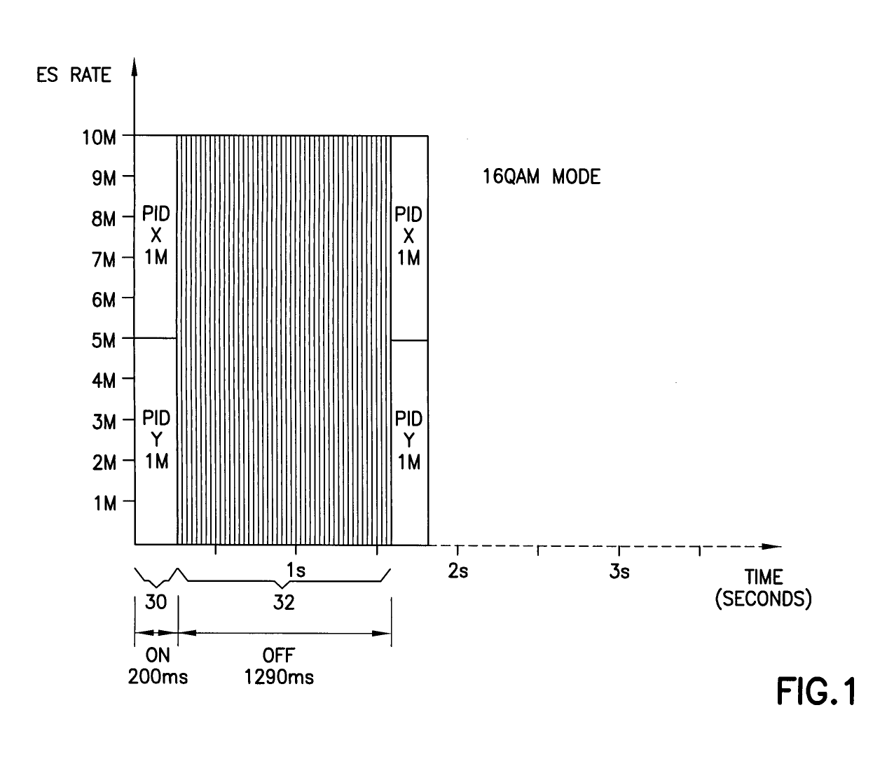

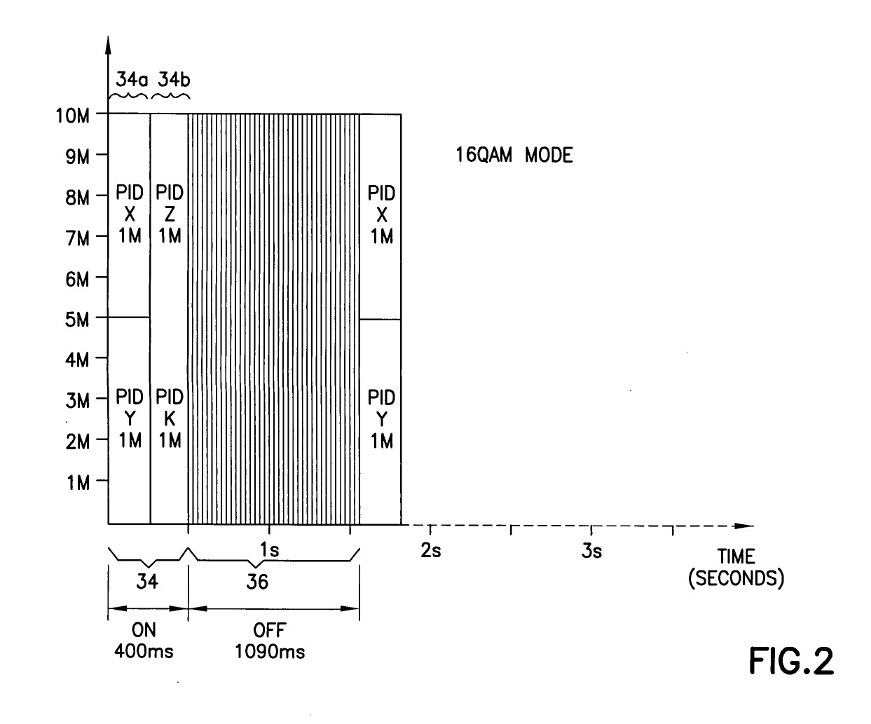

FIG. 1 illustrates a DVB-H receiver on-time 30 of 200 ms and off-time 32 of 1290 ms when operating in a 16-QAM mode, while FIG. 2 illustrates a worst-case scenario of the DVB-H receiver on-time 34 of 400 ms and off-time 36 1090 ms. The worst case configuration can occur when the mobile terminal is receiving one DVB-H service 34a and recording another one 34b. While the relative position of the two bursts 34a, 34b may vary, in the worst case scenario as illustrated they are adjacent to one another. The vertical axis of FIGS. 1-2 represent the elementary stream ES rate (in thousands of bits per second) for DVB-H, a data rate.

As detailed at page 7 of the incorporated document ETSI EN 302 304 V1.1.1 (2004-11), Digital Video Broadcasting (DVB); Transmission System for Handheld Terminals (DVB-H), the DVB-H system uses time slicing to reduce power consumption at the receiver. Time slicing consists of sending data is bursts using a significantly higher instantaneous bit rate as compared to the bit rate required if the data were transmitted using traditional streaming mechanisms. DVB-H indicates to the receiver a time (delta-t) within the current burst that indicates the beginning of the next burst. Between the bursts, data of the DVB-H elementary stream is not transmitted, allowing other ESs to use the bandwidth otherwise allocated. Time slicing enables a receiver to stay active only a fraction of the time, while receiving bursts of a requested service. Note that the transmitter of the DVB is always on (i.e., the transmission of the transport stream is not interrupted).

Time slicing is always used in DVB-H, and in characterizing the receiver below, the time-sliced signal is referred to from the receiver's perspective as a bursty communication having receiving periods (the bursts) and non-receiving periods (between the bursts). The receiver is considered to be in an active state during the receiving periods and in an inactive state during the non-receiving periods, where certain functions of the receiver are de-powered or operated at a reduced power level or frequency to conserve energy.

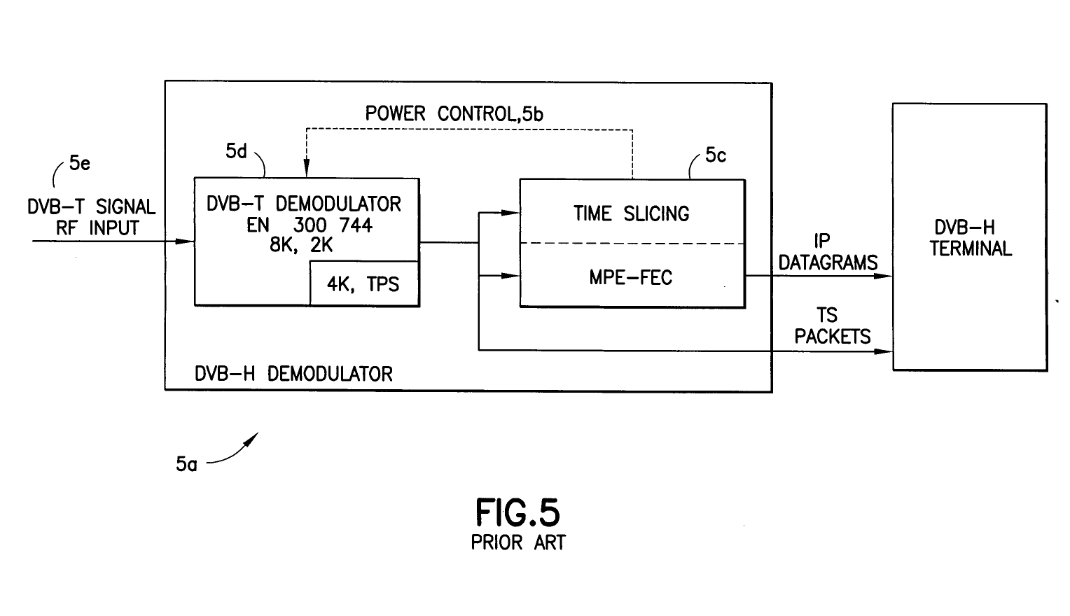

A prior art conceptual diagram of a DVB-H receiver 5a is shown at FIG. 5, where a power control signal 5b from a time slicing block 5c controls whether a DVB-T demodulator 5d is powered or not according to the delta-t's received in each of the packets of the DVB-T signal 5e. Operating with the DVB-T demodulator 5d depowered between the bursts is an example of operating the DVB-H receiver 5a in an inactive state. An active state is in a condition to receive and process the bursts of the DVB-H signal 5e, and the inactive state is in other than that condition. Without loss of generality, the below description refers to the periods of time during which the receiver is in an active and an inactive state as the receiver's on-time and off-time, respectively.

Time slicing also supports the possibility of the receiver monitoring neighboring cells during its off times, between bursts. By switching from reception of one stream to another during the off times, it is possible to perform a quasi-optimal handover decision as well as seamless service handover.

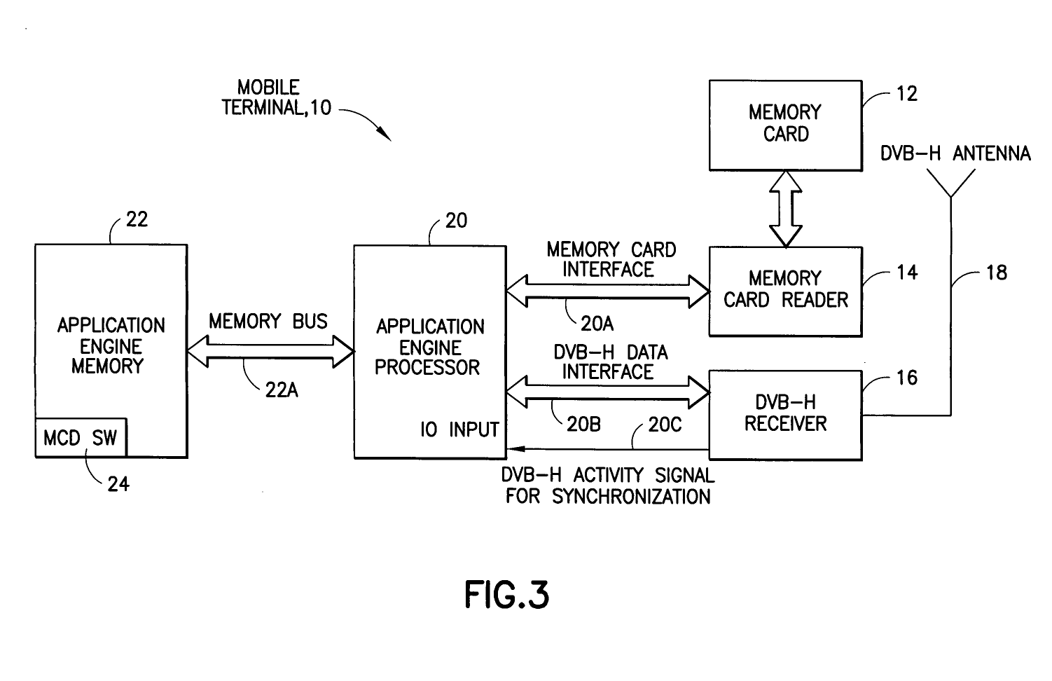

FIG. 3 is a simplified block diagram of a portion of a mobile terminal 10 related to synchronization of the operation of a memory card 12 and associated memory card reader 14 during DVB-H reception by a DVB-H receiver 16 having an input connected to a DVB-H antenna 18. The mobile terminal I 0 is assumed to include at least one data processor, referred to herein for convenience as an Application Engine Processor (AEP) 20 that in turn is bidirectionally coupled to an Application Engine Memory (AEM) 22 via memory bus 22A. The AEP 20 is also bidirectionally coupled to the memory card reader 14 and to the DVB-H receiver 16 via memory card interface 20A and a DVB-H data interface 20B, respectively. The AEP 20 may include the above-mentioned baseband circuitry for a non-limiting example where the mobile terminal 10 is embodied as a cellular phone.

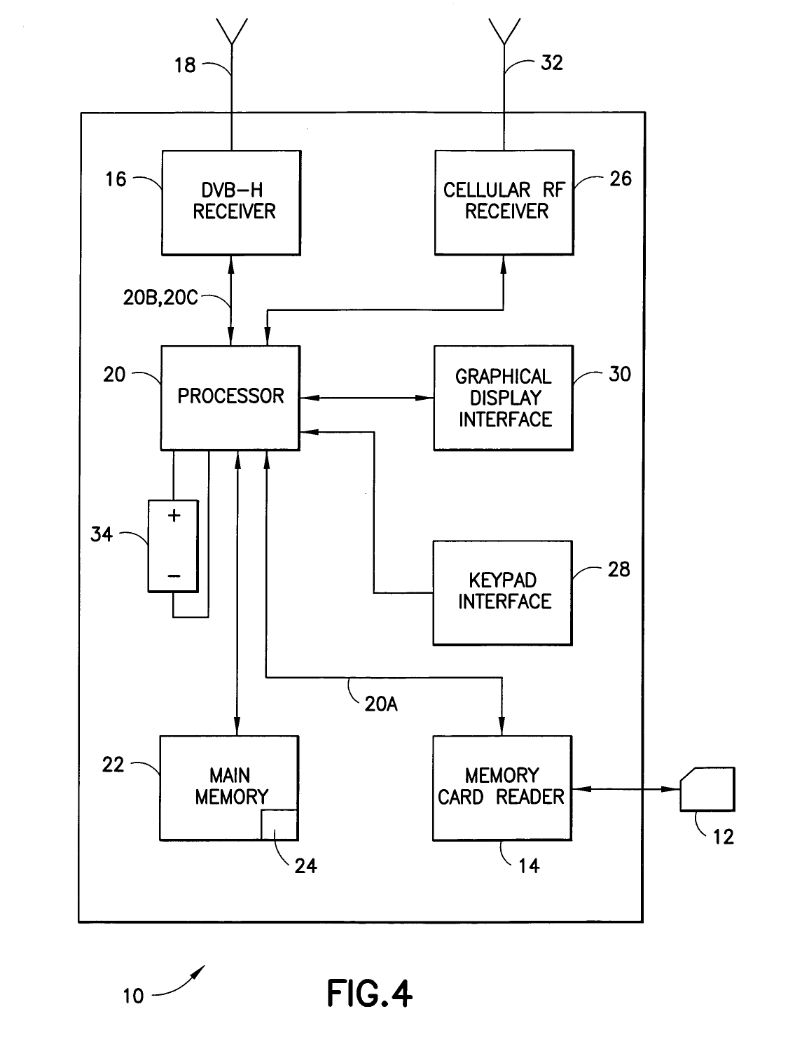

It should be further noted that for a case where the mobile terminal 10 comprises a cellular phone, the cellular phone related components, such as the cellular band(s) RF transceivers 26 and RF parts, are illustrated in FIG. 4 in addition to those components described with reference to FIG. 3 and bearing like reference numbers. Also shown in FIG. 4 is a user interface (UI), such as a keypad 28 and graphical display 30, and a portable power supply such as a galvanic battery 34. Note that while a cellular/PCS antenna 32 is shown as separate from the DVB-H antenna 18, the functions of both may be combined into a single multi-band antenna with multiple active elements for radiating in the respective frequency bands.

In general, the various embodiments of the mobile terminal 10 can include, but are not limited to, cellular phones, personal digital assistants (PDAs), portable computers, image capture devices such as digital cameras, gaming devices, music storage and playback appliances, Internet appliances, as well as portable units or terminals that incorporate combinations of such functions, and that further include a removable memory component 12 and a DVB-H receiver, or more generally any type of receiver that operates in frequency band that can potentially be adversely affected by EMI generated by operation of the removable memory component 12, particularly read and write operations.

Note that in both network configuration cases of FIGS. I and 2 the DVB-H receiver 16 is off (i.e., an inactive state) for over one second. This approximately one second period is assumed to provide the AEP 20 sufficient time communicate with the memory card 12.

In practice, the synchronization of the memory card 12 operation proceeds as follows.

Before the DVB-H receiver 16 is set to on via the DVB-H data interface 20B (which is assumed to include control and status related capabilities as well as data transfer capabilities), the memory card 12 is set to a state where its internal clock(s) are shut off, via the memory card interface 20A and the memory card reader 14. If the memory card 12 happens to have a defined “reset” state, then the memory card 12 may be commanded to enter the reset state. Also, before the DVB-H receiver 16 is set to the on state any data transmission in the memory card interface 20A is disabled. The DVB-H receiver 16 is then set to on and the received DVB-H data is collected into (i.e., buffered in) a mobile terminal 10 memory (RAM memory), such as the AEM 22, for the duration of the DVB-H receiver on-time (e.g., 200 ms (FIG. 1) or 400 ms (FIG. 2)). For example, assuming that a received DVB-H signal is being recorded, the DVB-H data is temporarily buffered in the AEM 22, since the memory card 12 is effectively disabled during the DVB-H receiver 16 reception period.

After the DVB-H receiver 16 is shut off the memory card 12 and memory card interface 20A operation is enabled, and the received and buffered DVB-H data is transferred from the mobile terminal memory (e.g., the AEM 22) to the memory card 12 memory. This can occur via the memory bus 22A, AEP 20, memory card interface 20A and memory card reader 14, or the AEP 20 could be bypassed if a DMA (Direct Memory Access) technique is employed. Since the DVB-H receiver 16 is off, any EMI that may be generated by operation of the memory card 12 and the memory card interface 20A does not affect the DVB-H receiver 16.

For a case where a user is watching a TV program, and there are memory card operations running in the background, the memory card operations may be synchronized in the same manner. The memory card 12 write and read operations are disabled when the DVB-H receiver 16 is on, and memory card 12 write and read operations are enabled when the DVB-H receiver 16 is off.

In one exemplary embodiment the DVB-H/memory card synchronization timing with AEP 20 may be accomplished by the use of a separate DVB-H activity signal 20C coupled to an I/O input of the AEP 20 where it can be polled, or coupled to an interrupt input of the AEP 20 for generating an interrupt on a change of state of the DVB-H receiver 16 operation. Alternatively, the DVB-H/memory card synchronization timing can be controlled through the use of SW timers implemented by the AEP 20. Some combination of SW timers and the DVB-H activity signal 20C may also be employed if desired. Note that in the case of SW synchronization it may be preferred to place this under control of the software subsystem that has immediate control over the memory card 12 and memory card interface 20A operations, e.g., under control of memory card driver (MCD) SW 24 that may be resident in the AEM 22.

One advantage of the use of the exemplary embodiments of this invention is that by preventing operation of the memory card 12 during a DVB-H reception period, the memory card 12 and memory card interface 20A do not cause interference into the DVB-H frequency band. The performance of the DVB-H receiver 16 (sensitivity-wise) thus remains the same during a recording function (when received DVB-H data is being stored locally in the mobile terminal 10 for subsequent playback).

Another advantage of the use of the exemplary embodiments of this invention is that it is clearly more cost effective that providing mechanical shielding, and also avoids changes in form factor, weight and complexity that maybe associated with a mechanical shielding approach.

Another advantage of the use of the exemplary embodiments of this invention is that one may decrease filter component count in the memory card interface 20A.

Based on the foregoing it will be appreciated that the exemplary embodiments of this invention may be implemented by computer software executable by the AEP 20, or by hardware, or by a combination of software and hardware. In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

Various modifications and adaptations may become apparent to those skilled in the relevant arts in view of the foregoing description, when read in conjunction with the accompanying drawings. However, any and all modifications of the teachings of this invention will still fall within the scope of the non-limiting embodiments of this invention.

Furthermore, some of the features of the various non-limiting embodiments of this invention may be used to advantage without the corresponding use of other features. As such, the foregoing description should be considered as merely illustrative of the principles, teachings and exemplary embodiments of this invention, and not in limitation thereof.

I claim:

1. A method of operating a mobile device comprising:
wirelessly receiving at a mobile device a bursty communication that comprises receiving periods and non-receiving periods;
synchronizing memory card operations within the mobile device to the non-receiving periods.

2. The method of claim 1, wherein synchronizing comprises turning off a clock for the memory card operations during the receiving periods and turning on the clock during the non-receiving periods.

3. The method of claim 1, wherein synchronizing comprises resetting a clock for the memory card operations during the receiving periods.

4. The method of claim 1, wherein synchronizing comprises:
during the receiving periods, buffering the received bursty communication in a random access memory and disabling the memory card operations; and
during the non-receiving periods, the memory card operations comprise writing the buffered bursty communication to a memory card.

5. The method of claim 1, wherein the bursty communication comprises a first bursty video channel having a first receiving period and a second bursty video channel having a second receiving period different from the first receiving period, wherein synchronizing comprises:
disabling the memory card operations during both the first and second receiving periods, and
storing at the memory card, during times excluding both the first and second receiving periods, the first bursty video channel but not the second bursty video channel.

6. The method of claim 5, further comprising displaying the second video channel during the non-receiving period, the first receiving period and the second receiving period.

7. The method of claim 1, wherein synchronizing comprises sending an activity signal from a digital video broadcast DVB receiver that receives the bursty communication to a processor of the mobile device, said activity signal indicative of an on or off state of the DVB receiver.

8. The method of claim 1, wherein synchronizing comprises generating and sending an interrupt command from a digital video broadcast DVB receiver that receives the bursty communication to a processor of the mobile device, said interrupt command indicative of a receiving state of the DVB receiver, wherein the DVB receiver changes to the receiving state for each of the receiving periods.

9. The method of claim 1, further comprising:
determining that the bursty communication is received at a frequency band within one of 470-750 MHz or 1440-1790 MHz;
and wherein the synchronizing is conditional on the determining.

10. A mobile terminal comprising:
a receiver configured to receive a bursty communication, said bursty communication comprising receiving periods and non-receiving periods;
a processor coupled to the receiver through a receiver interface;
a mass media interface for coupling a removable mass memory device to the processor;
software embodied on a computer readable medium that operates with the processor to synchronize reading and writing operations that pass through the interface with the non-receiving periods.

11. The mobile terminal of claim 10, wherein the mass media interface comprises a memory card reader configured to receive a removable memory card, wherein the software operates with the processor to synchronize by turning off an internal clock of a memory card disposed in the reader during the receiving periods and turning on the clock during the non-receiving periods.

12. The mobile terminal of claim 10, wherein the mass media interface comprises a memory card reader configured to receive a removable memory card, wherein the software operates with the processor to synchronize by resetting an internal clock of the memory card during the receiving periods.

13. The mobile terminal of claim 10, further comprising a random access memory coupled to the processor, wherein the software operates with the processor to synchronize by:
storing the received bursty communication in the random access memory during the receiving periods; and
writing the stored bursty communication from the RAM to a removable mass memory device coupled to the mass media interface during the non-receiving periods.

14. The mobile terminal of claim 10, wherein the bursty communication comprises a first bursty video channel having a first receiving period and a second bursty video channel having a second receiving period different from the first receiving period;
the mobile terminal further comprising a display coupled to the processor; and wherein the software operates with the processor to synchronize the reading and writing operations by:
disabling the reading and writing operations during both the first and second receiving periods, and
storing at a mass memory device that is coupled to the mass media interface, during times excluding the first and second receiving periods, the first bursty video channel but not the second bursty video channel.

15. The mobile terminal of claim 14, wherein the display is configured to display the second video channel during the non-receiving period, the first receiving period and the second receiving period.

16. The mobile terminal of claim 10, wherein the receiver comprises a digital video broadcast DVB receiver configured to send an activity signal to the processor, said activity signal indicative of an on or off state of the DVB receiver;
and further wherein the software operates with the processor to synchronize the reading and writing operations based on the activity signal.

17. The mobile terminal of claim 10, wherein the receiver comprises a digital video broadcast DVB receiver configured to generate and send an interrupt command to the processor, said interrupt command indicative of a receiving state of the DVB receiver, said DVB receiver changing to the receiving state for each of the receiving periods.

18. The mobile terminal of claim 10, wherein the software operates with the processor to synchronize the reading and writing operations when it is determined that the bursty communication is received at a frequency band within one of 470-750 MHz or 1440-1790 MHz.

19. A program of machine-readable instructions, tangibly embodied on a computer readable memory and executable by a digital data processor, to perform actions directed toward synchronizing read and write operations with a bursty communication, the actions comprising:
disabling read and write operations for a removable mass memory device when a wireless receiver is receiving the bursty communication, where the removable mass memory device is separate from the said computer readable memory; and
enabling said read and write operations when the wireless receiver is not receiving the bursty communication.

20. The program of claim 19, wherein disabling and enabling comprises controlling a clock internal to the mass memory device to run only when the wireless receiver is not receiving the bursty communication.

21. The program of claim 19, wherein disabling and enabling comprises generating and outputting activity state signals indicative of a respective receiving and a non-receiving state of the wireless receiver, wherein said disabling and enabling are based on the activity state signals.

22. The program of claim 19, wherein
disabling comprises generating an interrupt command when the wireless receiver is receiving the bursty communication, said interrupt command indicative of a receiving state of the DVB receiver; and
enabling comprises discontinuing generation of the interrupt command when the wireless receiver is not receiving the bursty communication.

23. A mobile communications device comprising:
receiving means configured to receive a bursty communication that comprises receiving periods and non-receiving periods;
processing means coupled to the receiving means;
interface means for removably coupling a removable memory device to the processor;
software embodied on a computer readable medium that operates with the processing means to synchronize memory operations that use the interface means with the non-receiving periods.

24. The mobile communications device of claim 23, wherein:
the receiving means comprises a digital video broadcast receiver and the bursty communication comprises a digital video broadcast;
the processing means comprises a digital processor; and
the interface means comprises a memory card reader for removably coupling a memory card device to the processor.

25. The mobile communications device of claim 24, further comprising a keypad configured to receive a user input.
